(19) United States
(12) Patent Application Publication
(10) Pub. No.: US 2014/0051302 A1
(43) Pub. Date: Feb. 20, 2014

(54) ELECTRICAL CONNECTOR WITH DETECT CONTACT

(71) Applicant: Hon Hai Precision Industry Co., Ltd., New Taipei (TW)

(72) Inventors: CHUN-MING YU, Kunshan (CN); JI-CHAO WANG, Kunshan (CN); GUO-HUA ZHANG, Kunshan (CN); ZHEN SU, Kunshan (CN); QI-SHENG ZHENG, Kunshan (CN)

(73) Assignee: HON HAI PRECISION INDUSTRY CO., LTD., New Taipei (TW)

(21) Appl. No.: 13/966,307

(22) Filed: Aug. 14, 2013

(30) Foreign Application Priority Data
Aug. 14, 2012 (CN) 201220400576.3

(51) Int. Cl. H01R 13/641

(52) U.S. Cl. CPC H01R 13/641
USPC 439/660

(57) ABSTRACT

An electrical connector (100) includes an insulative housing (1), a plurality of contacts (3) received in the insulative housing (1), a shielding shell (6) enclosing the insulative housing (1) and a detecting contact (41). The insulative housing (1) includes a tongue (22) extending forwardly and enclosed by the shell (6) to form a mating space (101). The detecting contact (41) includes a first extending arm (413) extending into the mating space (101) horizontally and a first resisting portion (414) extending forwardly and bent from the first extending arm (413). The tongue (22) has a first recess (2231) depressing inside thereof. The first resisting arm (414) extends into the first recess (2231) and improves a deformation of the detect contact (41) to offer a stronger force for abutting against the shell.

### BACKGROUND OF THE INVENTION

1. Field of the Invention

The present invention generally relates to an electrical connector and more particularly to an electrical connector with a detect contact retained to an insulative housing of the electrical connector.

2. Description of Related Art

Chinese patent No. 102082370A, published on Jun. 1, 2011, discloses an electrical connector including an insulative housing, a plurality of contacts retained in the insulative housing, a detect contact and a shield shell. The insulative housing includes a main portion and a tongue extending forwardly from the main portion. The main portion has a retaining slot located in a right side thereof for receiving the detect contact. The detect contact includes a retaining portion retained in the retaining slot, an elastic arm extending forwardly from the retaining portion and a detecting portion extending forwardly from an end of the elastic arm. The elastic arm is located between the tongue and shield shell and under the tongue. When a mating plug is inserted in, the detecting portion contacts with the shell to detect. But, the deformation degree of the detecting portion is so little, corresponding pressing force may be not enough to make the detecting portion reliably contact with the shell for influencing the effect of detecting.

So, an improved connector is needed.

### SUMMARY OF THE INVENTION

The present invention provides an electrical connector, the electrical connector comprises an insulative housing, a plurality of contacts received in the insulative housing, a shield shell enclosing the insulative housing to form a mating space and at least a detect contact. The insulative housing includes a tongue extending horizontally, the tongue including a top face, a bottom face opposite to the top face, a left side face and a right side face connecting the top face and the bottom face. The detect contact includes a first detecting contact located on one side thereof facing to the tongue, the first detecting contact has a first extending arm extending into the mating space horizontally and a first resisting portion extend forwardly and bend from the first extending portion, the tongue has a first recess depressing inwardly thereof, the first resisting portion extends into the first recess.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is an assembled perspective view of an electrical connector according to a preferred embodiment of the present invention;

FIG. 2 is a partially exploded perspective view of the electrical connector;

FIG. 3 is another partially exploded view of the electrical connector as shown in FIG. 2;

FIG. 4 is a partially exploded perspective view of the electrical connector without a shield shell;

FIG. 5 is an exploded view of the electrical connector;

FIG. 6 is another exploded view of the electrical connector as shown in FIG. 5;

FIG. 7 is a cross-sectional view of the electrical connector, taken along line 7-7 of FIG. 1;

FIG. 8 is similar with FIG. 7, showing a statue of a first detecting contact of the electrical connector when a standard USB plug insert in;

FIG. 9 is similar with FIG. 8, showing a statue of the first detecting contact of the electrical when an USB PD plug insert in

### DETAILED DESCRIPTION OF THE INVENTION

Reference will now be made to the drawing figures to describe the preferred embodiment of the present invention in detail.

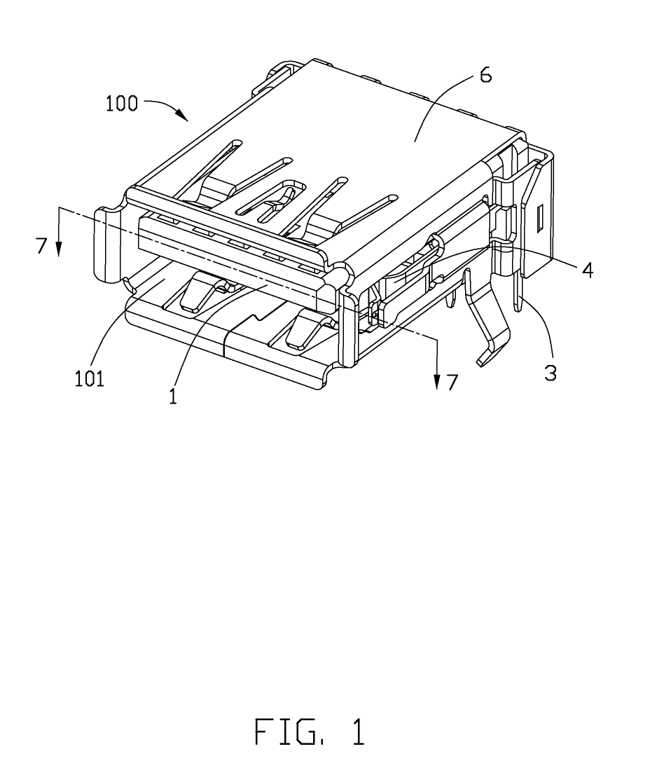

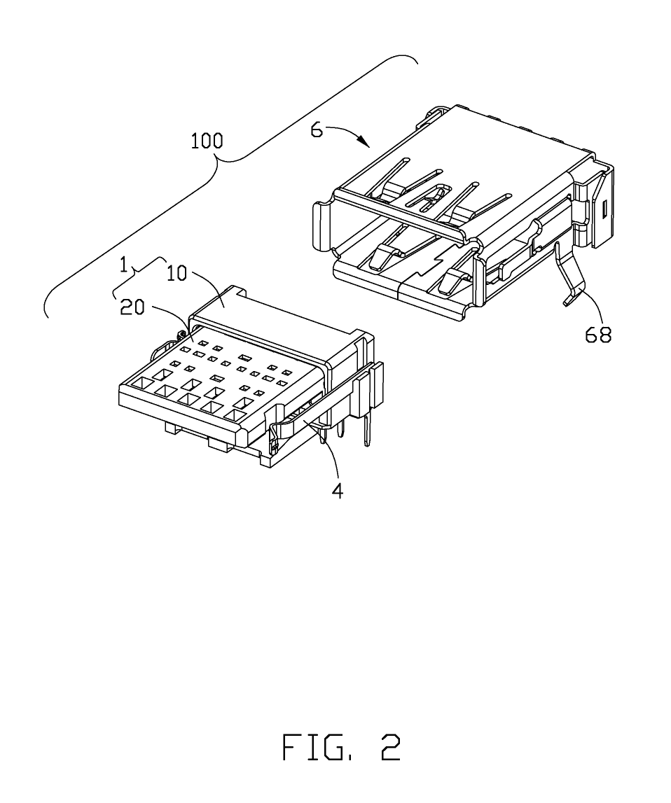

Referring to FIGS. 1-3, an electrical connector 100 is an USB (Universal Serial BUS) 3.0 connector comprises a mating port for receiving not only USB 3.0 plug but also USB PD (Power Delivery) plug for transmitting a power current up to 2 A. When the USB 3.0 plug and the USB PD plug insert respectively, the PCB on which the electrical connector 100 is mounted can detect which plug insert into so as to achieve different transmission. The electrical connector 100 comprises an insulative housing 1, a plurality of contacts 3 received in the insulative housing 1, a pair of detect contacts 4, a spacer 5 mounting into a rear of the insulative housing 1 for retaining the contacts 3 and a shield shell 6 enclosing the insulative housing 1.

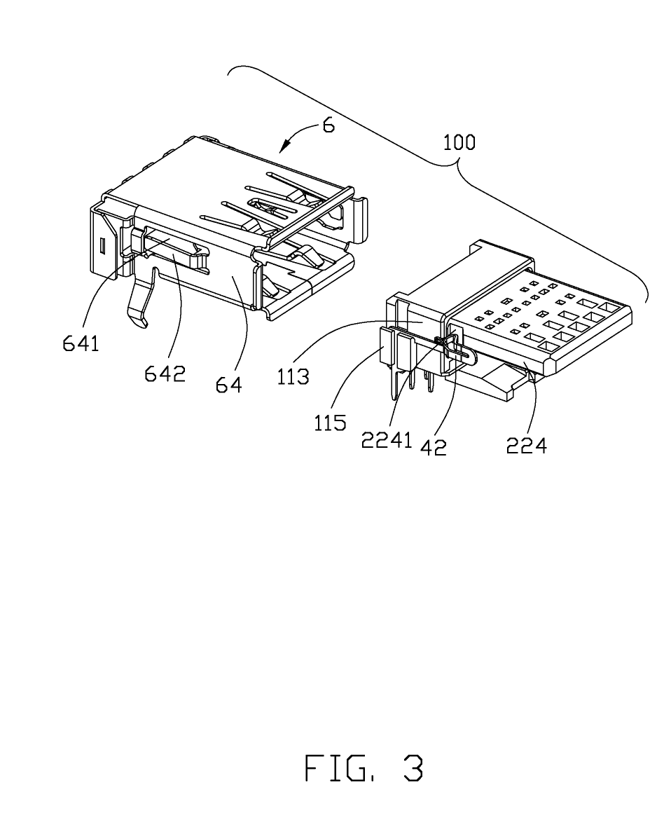

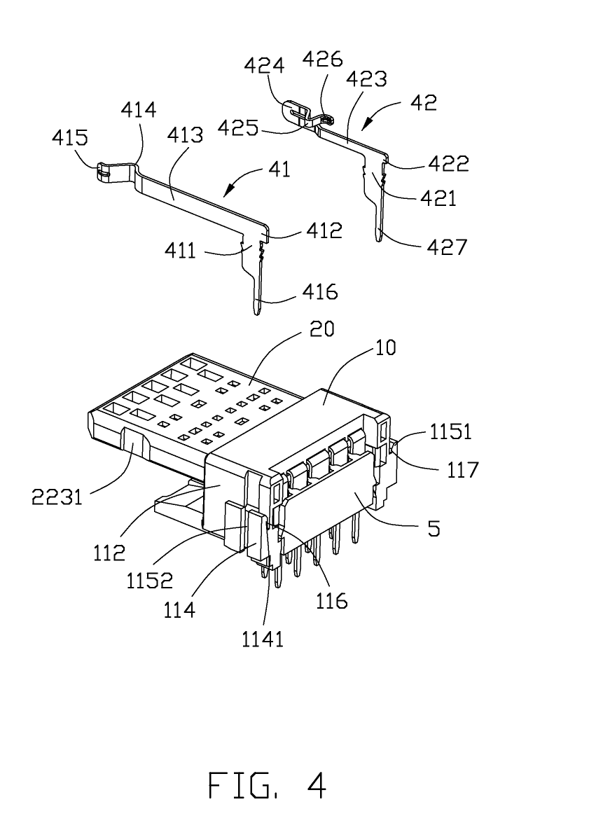

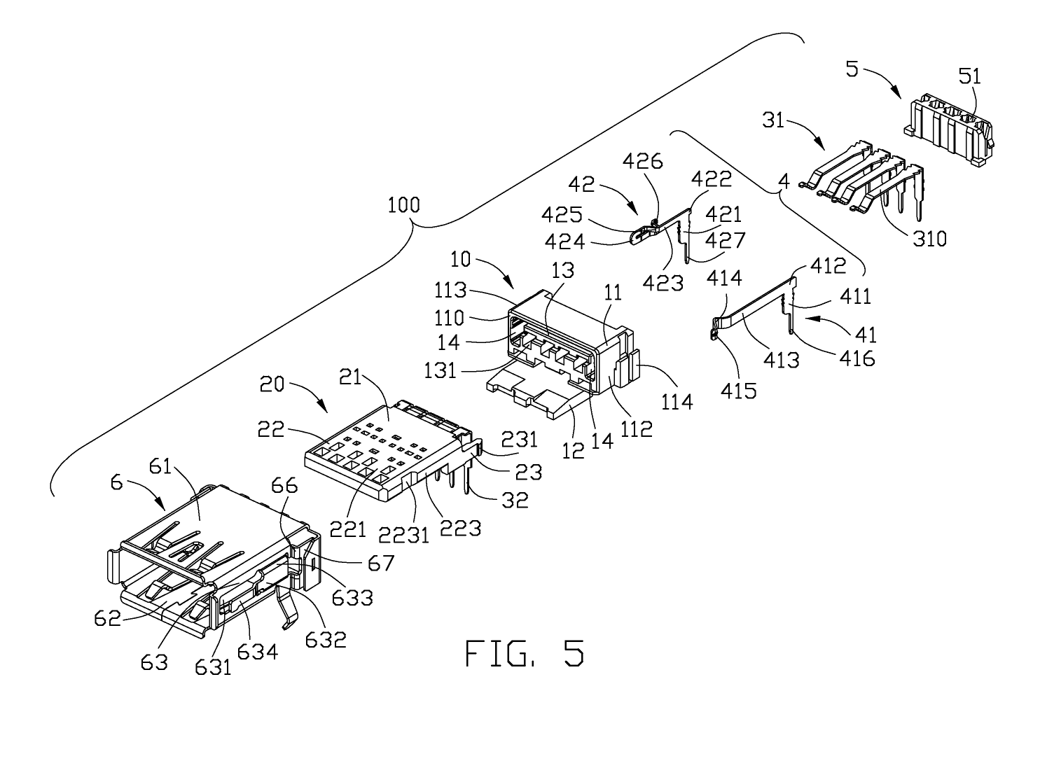

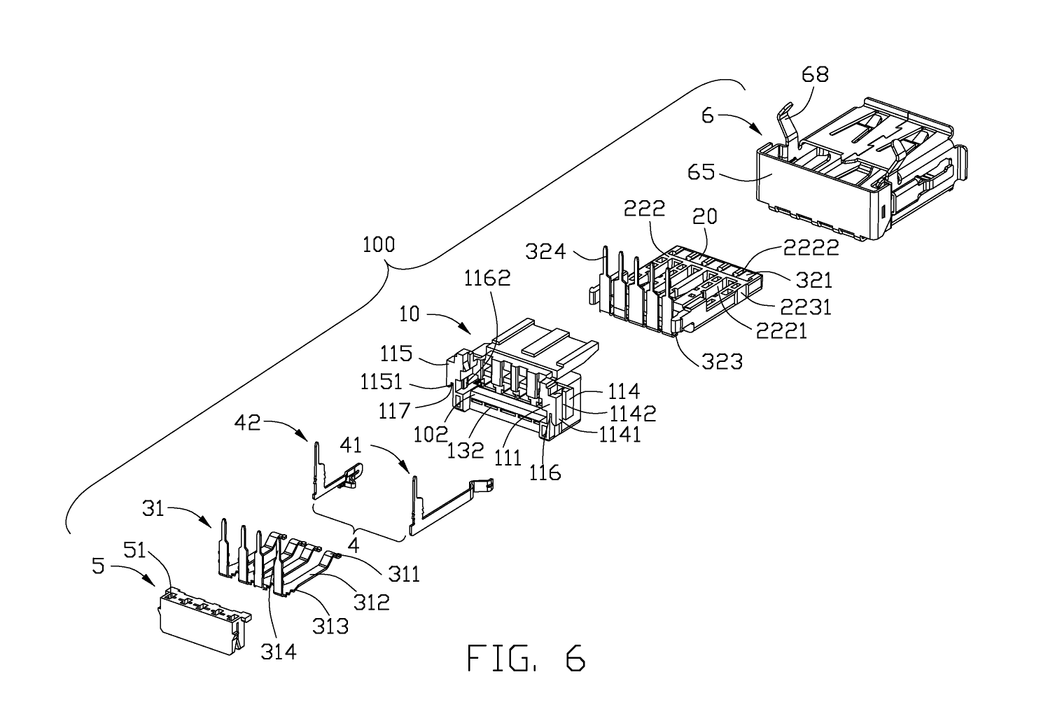

Referring to FIGS. 3-6, the insulative housing 1 includes a first body portion 10 and a second body portion 20 assembled into the first body portion 10 along a front to rear direction. The shield shell 6 and the insulative housing 1 define a mating space 101 for receiving a mating connector (not shown). The first body portion 10 includes a main portion 11 and a supporting portion 12 extending forwardly from a bottom of the main portion 11. The main portion 11 includes a front wall 110, a rear wall 111 opposite to the front wall 110, a left side wall 112 and a right side wall 113 both connecting the front wall 110 with the main portion 111. The main portion 11 includes a first passageway 13 passing backwardly from the rear wall 111 and two second passageways 14 extending downwardly from two sides of the first passageway 13. The second passageways 14 pass through the insulative housing 1 along a front to rear direction.

The left and right side walls 112, 113 have a first and second retaining block 114, 115 extending outwardly, respectively. The first and second retaining blocks 114, 115 each have first and second extending portions 1141, 1151 extending upwardly. A first attaching slot 116 is formed between the first retaining block 114 and the left side wall 112. A second attaching slot 117 is formed between the second retaining block 115 and the right side wall 113. The first retaining block 114 has a first retaining slot 1142 passing therethrough along an upper to down direction and the second block 115 has a second retaining slot 1152 passing therethrough along the upper to down direction.

An accommodating space 102 is depressed forwardly from the rear wall 111. The second passageways 14 each have a convex 1162 extending inwardly from an inside surface thereof A plurality of first receiving slots 131 pass through the insulative housing 1 along the front to rear direction and located under the first passageway 13. The first receiving slots 131 are located between two second passageways 14. The rear wall 111 of the main portion 11 has a plurality of second receiving slots 132 passing through the insulative housing 1 along the front to rear direction and located above the first passageway 13.

The second body portion 20 includes a base 21 received in the first passageway 13, a tongue 12 extending forwardly from the base 21 and a pair of retaining arms 23 received in the second passageways 14. The retaining arms 23 each have a latching portion 231 extending outwardly and latching with the convexes 1162 of the second passageways 14. The tongue 22 includes a top face 221, a bottom face 222 opposite to the top face 221, a left side face 223 and a right side face 224 connecting the top face 221 and the bottom face 222. The bottom face 222 has a plurality of receiving cavities 2221 depressed upwardly therefrom and passing through the base 21 backwardly. The bottom face 222 further has a plurality of accommodating slots 2222 depressed upwardly form a front thereof. The accommodating slots 2222 are located in the front of the receiving cavity 2221. The receiving cavities 2221 are communicated with the first receiving slots 131 along the front to rear direction. The left side face 223 has a first recess 2231 depressed inwardly thereof and the right side face 224 has a second recess 2241 depressed inwardly thereof. The first recess 2231 closes to a front edge of the tongue 22 rather than the second recess 2241.

The contacts 3 include a first group of contacts 31 and a second group of contacts 32. The first group of contacts 31 is a group type A USB 2.0 contacts for contacting with a type A USB 2.0 plug. The first and second groups of the contacts 31, 32 are combined a group type A USB 3.0 contacts for contacts with a type A USB 3.0 plug. The first group of contacts 31 has four first contacts 310 each including a first retaining portion 313 received in the first receiving slot 131, a first connecting portion 312 extending forwardly from the first retaining portion 313 and into the receiving cavity 2221 of the tongue 22, an elastic contacting portion 311 extending forwardly and aslant from the connecting portion 312 and exposed outside, and a first soldering portion 314 extending downwardly from a rear of the first retaining portion 313.

The second group of contacts 32 has five second contacts 320. The second contacts 320 each have a second retaining portion 323 received in the second receiving slot 132, a second connecting portion (not shown) extending forwardly from the retaining portion 323 and insert-molded in the tongue 22, a contacting portion 321 extending forwardly from the connecting portion (not shown) and received in the accommodating slot 2222 of tongue 22 and a soldering portion 324 extending downwardly from a rear of the retaining portion 323. The second contacting portion 321 is a plate shape. The first contacting portion 311 and the second contacting portion 321 are separated in the front-to-rear direction and in different height along the upper to down direction. The first soldering portions 314 are arranged one row. The second soldering portion 324 arranged in another row behind the first soldering portion 314 and parallel to the row of the first soldering portion 314.

The detect contacts 4 include a first detecting contact 41 mounted in the left side wall 112 of the insulative housing 1 and a second detecting contact 42 mounted in the right side wall 113 of the insulative housing 1. The first detecting contact 41 is used for detecting if the USB plug inserts into. The second detecting contact 42 is used for detecting if the USB PD plug inserts into. The first detecting contact 41 includes a first vertical portion 411 retained in the first retaining slot 1142 of the first retaining block 114, a first retaining arm 412 extending forwardly from a top side of the first vertical portion 411 and received in the first attaching slot 116, a first extending portion 413 extending forwardly from the first retaining portion 412 and beside left side face 223 of the tongue 22, a first resisting portion 414 extending forwardly from the first extending arm 413 and into the first recess 2231, a first attaching portion 415 extending forwardly from the first resisting portion 414 and a first soldering tail 416 extending downwardly from the first vertical portion 411. The first resisting portion 414 is disposed as a V-shaped from a top side. The first detecting contact 41 extends downwardly beyond the bottom face 222 of the tongue 22 partly.

The second detecting contact 42 includes a second vertical portion 421 retained in the second retaining slot 1152 of the second retaining block 115, a second retaining arm 422 extending forwardly from a top side of the second vertical portion 421 and retained in the second attaching slot 117, a second extending arm 423 extending forwardly from the second retaining arm 422 and beside the right side face 224, a bending portion 424 extending aslant from the second extending arm 423, a second resisting portion 425 extending aslant from the bending portion 424 and into the second recess, a second attaching portion 426 extending backwardly from the second resisting portion 425 and a soldering tail 427 extending downwardly from the second vertical portion 421 and out of the insulative housing 1. The second resisting portion 425 is disposed as a V-shaped. A height of the first vertical portion 411 is same as that of the first attaching slot 116 along the up to down direction. A height of the second vertical portion 421 is same as that of the second attaching slot 117 along the up to down direction. The first resisting portion 414 is close to the front edge of the tongue 22 nearer than the second resisting portion 425. A bottom edge of the first resisting portion 414 is located below the bottom face 222 of the tongue 22. The second resisting portion 425 is located between the top face 221 and bottom face 222 of the tongue 22 along the upper to down direction.

The spacer 5 is disposed as a rectangle-shaped and comprises a plurality of receiving passageways 51 passing therethrough for receiving the first and second soldering portions 416, 417. The spacer 5 is mounted into the accommodating space 102 of the insulative housing 1 from a bottom side.

The shield shell 6 is made by a metal plate. The shell 6 includes a top end wall 61, a bottom end wall 62 opposite to the top end wall 61, a left end wall 63, a right end wall 64 and a rear wall 65 bending downwardly from a rear edge of the top end wall 61. The left and right end walls 63, 64 each have a lump 66 extending vertically and outwardly thereof and an extending wall 67 extending backwardly and vertically from the lump 66. The left end wall 63 of the shell 6 protrudes partly to define a first space 631. The shell 6 has a plate portion 632 located in outside of the left end wall 63, an aslant portion 633 connecting the plate portion 632 and the left end wall 63 and a first elastic plate 634 extending forwardly from the plate portion 632. The first elastic plate 634 dangles beside the first space 631. The right end wall 64 of the shell 6 protrudes partly to define a second space 641. The right end wall 64 has a second elastic plate 642 dangling beside the second space 641. The first and second spaces 631, 641 are used for receiving the first resisting portion 414 of the first detecting contact 41 and the second resisting portion 425 of the second detecting contact 42. The first and second first and second elastic plates 634, 642 are formed by stamping of the first and second spaces 631, 641 to offer a deformation space of the first and second detecting contacts 41, 42. In other embodiment, the left and right end wall 63, 64 can directly stamp outwardly to form a closed swing space for receiving the first and second detecting contact 41, 42. The left and right end walls 63, 64 each have a mounting tail 68 extending downwardly therefrom and near the rear wall 65.

The insulative housing 1 is assembled into the shield shell 6 along a back to front direction. The first and second retaining block 114, 115 resist the lump 66 forwardly. The first detecting contact 41 is located inside of the first elastic plate 634 and detect outwardly from the first space 631. The second detecting contact 42 is located inside of the second elastic plate 642 and outwardly from the second space 641.

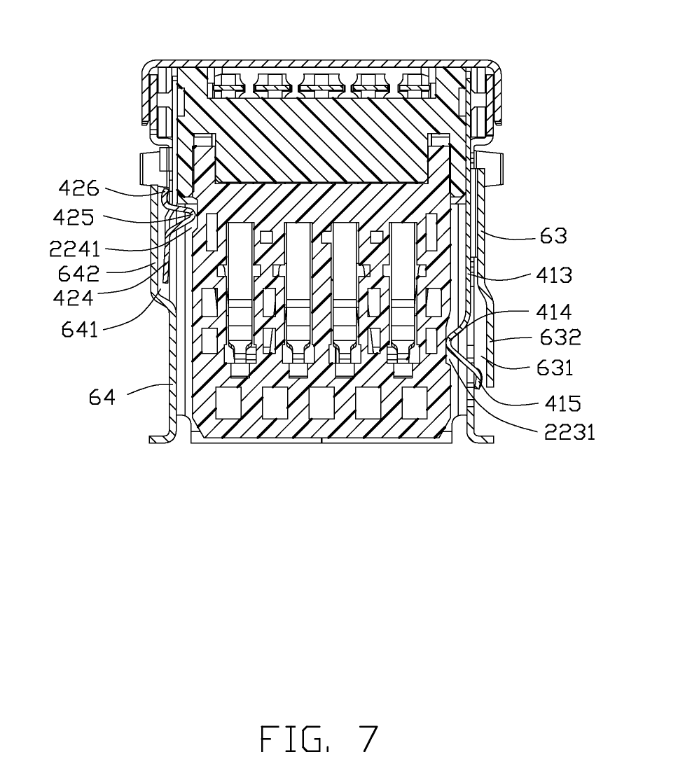

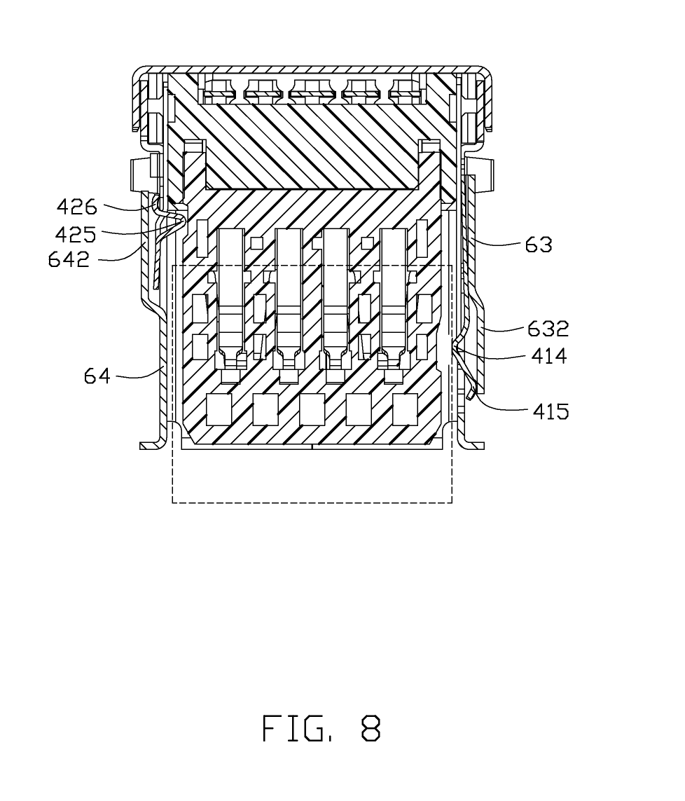

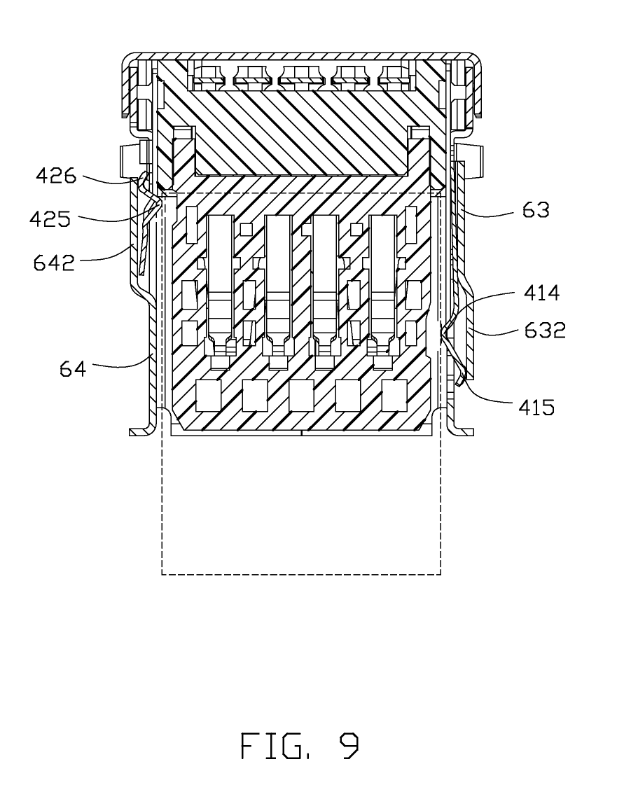

Referring to FIGS. 7-9, they show a number of different kinds elements insert into the electrical connector 100. Referring to FIG. 7, in the initial state, the first and second resisting portions 414, 425 do not contact with the shield shell 6. Referring to FIG. 8, when USB 3.0 plug, a shorter and ordinary plug, inserts into. A short mating portion of the ordinary plug can not tough a deepest part of the mating space 101. The ordinary plug only push the second resisting portion 425 received in the second recess 2231 to make the second resisting portion 425 contact with the second elastic plate 642 of the shell 6, while the first detecting contact 41 keep the initial state; referring to FIG. 9, when USB PD plug, a power plug having a longer mating portion, inserts into, the longer mating portion resists both the first and second resisting portions 414, 425 contact with the first and second elastic plates 634, 642, respectively; when a thin card (not shown) inserts into, a mating portion of the thin card is enough long and extends to the deepest part of the mating space 101. Bur the thin card is disposed as a plate-shaped and only received in a space under the tongue 20. The bottom edge of the first detecting contact 41 does not extend downwardly beyond the bottom face 222 of the tongue 2. So, the thin card only resist the second resisting portion 425 of the second detecting contact 42 to make the second detecting contact 42 contact with the second elastic plate 642 of the shell 6, while the first detecting contact 41 keep its original position.

The left and right side faces 223, 224 of have the first recess 2231 and second recess 2241 respectively. The first resisting portion 414 of the first detecting contact 41 extends into the first recess 2231 and the second resisting portion 425 extends into the second recess 2241 to improve the deformation degree of the first and second resisting portions 414, 425 received in the first and second recesses 2231, 2241. It would improve the pressing force of end of first and second resisting portions 414, 425 resisting the first and second elastic plates 634, 642 of the shield shell 6 to ensure the effect of detecting.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
an insulative housing having a tongue extending horizontally, the tongue including a top face, a bottom face opposite to the top face, a left side face and a right side face connecting the top face and the bottom face;
a plurality of contacts received in the insulative housing;
a shield shell enclosing the insulative housing to form a mating space; and
at least a detect contact including a first detecting contact located on a side of the tongue, the first detecting contact having a first extending arm horizontally extending into the mating space and a first resisting portion extending forwardly and bending from the first extending portion, the tongue having a first recess depressing inwardly from one of the side faces thereof, the first resisting portion extending into the first recess.

2. The electrical connector as claimed in claim 1, wherein the first resisting portion is disposed as a V-Shaped, the first detecting contact further includes a first attaching portion extending forwardly from the first resisting portion and out of the first recess to contact with the shell.

3. The electrical connector as claimed in claim 1, wherein the detect contact further a second detecting contact, the tongue has a second recess depressed inwardly from another side face of tongue, the second detecting contact includes a second resisting portion extending into the second recess and a second attaching portion extending out of the second recess, the second resisting portion is disposed as a V-Shaped and the attaching portion contacts with the shell.

4. The electrical connector as claimed in claim 3, wherein the first recess is depressed from the left side face of the tongue and the second recess is depressed from the right side face of the tongue.

5. The electrical connector as claimed in claim 3, wherein the first resisting portion of the first contact extends downwardly beyond the bottom face of the tongue, and the second resisting portion is located between the top and bottom faces of the tongue.

6. The electrical connector as claimed in claim 3, wherein the second detecting contact includes a second extending arm extending forwardly and into the mating space, a bending portion extending forwardly and bent backwardly from the second extending arm, the second resisting portion extends into the second recess from the bending portion.

7. The electrical connector as claimed in claim 3, wherein the first recess is close to a front edge of the tongue rather than the second recess.

8. The electrical connector as claimed in claim 3, wherein the insulative housing includes a first body portion and a second body portion assembled into the first body portion along a front to rear direction, the first body portion has a main portion including a front wall, a rear wall, a left side wall and a right side wall, the left and right side walls each have a first retaining block and a second retaining block respectively, the first retaining block has a first extending portion extending upwardly from a top thereof and the second retaining block has a second extending portion extending upwardly from a top thereof, the first extending portion and the left side wall formed with a first attaching slot, the second extending portion and the right side wall are formed with a second attaching slot.

9. The electrical connector as claimed in claim 8, wherein the first retaining block has a first retaining slot passing through a middle thereof and the second retaining block has a second retaining slot passing through a middle thereof, the first and second detecting contact each have a first vertical portion retained in the first retaining slot and a second vertical portion retained in the second retaining slot, a first retaining arm extends from a top end of the first vertical portion and a second retaining arm extends from a top end of the second vertical portion.

10. The electrical connector as claimed in claim 3, wherein the shell includes a top end wall, a bottom end wall, a left end wall and a right end wall, the left end wall has a first space and a first elastic plate dangling out of the first space, the right end wall has a second space and a second elastic plate dangling out of the second space, the first detecting contact is located in the first swing portion to contact with or disconnect with the first elastic plate, the second detecting contact is located in the second space to contact with or disconnect with the second elastic plate, the first and second elastic plates extend out of the left and right end walls respectively.

11. The electrical connector as claimed in claim 8, wherein the shell includes a left end wall and a right end wall, the left and right end walls each have a lump extending vertically and an extending wall extending backwardly and vertically from the lump, the first and second retaining blocks resist the lumps forwardly.

12. An electrical connector comprising:
an insulative housing having a main portion and a tongue extending forwardly from the main portion, the tongue including a top face, a bottom face opposite to the top face, a left side face and a right side face connecting the top face and the bottom face;
a plurality of contacts received in the insulative housing;
a shield shell including a top end wall, a bottom end wall, a left end wall and a right end wall; and
at least a detect contact unit including a first detecting contact located between one of the side faces and shell, the detecting contact retained in the main portion of the insulative housing and having a first extending arm extending forwardly horizontally and a first resisting portion extending forwardly and bent from the extending arm, the tongue having a first recess depressed inwardly from the one of the side face to receive the first resisting portion.

13. The electrical connector as claimed in claim 12, wherein the first resisting portion is disposed as a V-Shaped, the first detecting contact further includes a first attaching portion extending forwardly from the first resisting portion and out of the first recess to contact with the shell.

14. The electrical connector as claimed in claim 12, wherein the detect contact unit further comprises a second detecting contact, the tongue has a second recess depressed inwardly from another side face of tongue, the second detecting contact includes a second resisting portion extending into the second recess and a second attaching portion extending out of the second recess, the second resisting portion is disposed as a V-Shaped and the attaching portion contacts with the shell, the first recess is depressed from the left side face of the tongue and the second recess is depressed from the right side face of the tongue, the second detecting contact includes a second extending arm extending forwardly and into the mating space, a bending portion extending forwardly and bent backwardly from the second extending arm, the second resisting portion extends into the second recess from the bending portion.

15. An electrical connector for use with a plug, comprising:
an insulative housing defining a base and a mating tongue forwardly extending therefrom along a front-to-back direction;
a recess formed in an face of the mating tongue;
a plurality of contacts disposed in the housing with contacting sections exposed upon the mating tongue;
a metallic shell enclosing said housing and cooperating with the mating tongue to form a receiving cavity for receiving the plug; and
a detect pin disposed in the housing with a detecting portion deflectable in a transverse direction perpendicular to said front-to-back direction;
wherein
said detecting portion defines a contacting apex region adapted for abutting against a metallic shield of the plug during mating and received in the recess.

16. The electrical connector as claimed in claim 15, wherein the mating tongue extends along a horizontal plane defined by the front-to-back direction and a horizontal direction perpendicular to said front-to-back direction, and said detect pin is located beside the mating tongue in said horizontal direction.

17. The electrical connector as claimed in claim 16, wherein said face of the mating tongue is a side face defined by said front-to-back direction and a vertical direction perpendicular to both said front-to-back direction and said horizontal direction.

18. The electrical connector as claimed in claim 17, wherein the metallic shell defines a deformation space for allowing outward deflection of the detect pine.

19. The electrical connector as claimed in claim 18, wherein said detecting pin defines an abutment portion abutting against the metallic shell during mating.

20. The electrical connector as claimed in claim 19, wherein the abutment portion abuts against the metallic shell at a position which is located behind the contacting apex region in the front-to-back direction.
